(19) United States
(12) Patent Application Publication
(10) Pub. No.: US 2025/0346366 A1
(43) Pub. Date: Nov. 13, 2025

(54) BATTERY CHARGING SYSTEM FOR AIRCRAFT AND AEROSPACE VEHICLES

(71) Applicant: BAE Systems Controls Inc., Endicott, NY (US)

(72) Inventors: Joshua T. Pendleton, Vestal, NY (US); Michael Mallery, Apalachin, NY (US); Matthew S. Boecke, Endicott, NY (US)

(73) Assignee: BAE Systems Controls Inc., Endicott, NY (US)

(21) Appl. No.: 18/662,062

(22) Filed: May 13, 2024

(51) Int. Cl. B64F 1/35; H01M 10/42; H01M 10/613; H01M 10/625; H02J 7/00; H02J 7/34

(52) U.S. Cl. CPC B64F 1/352; H01M 10/425; H01M 10/613; H01M 10/625; H02J 7/00036; H02J 7/00304; H02J 7/00308; H02J 7/0031; H02J 7/0049; H02J 7/342; H01M 2010/4271; H01M 2010/4278

(57) ABSTRACT

A portable energy charging system and method for remote, isolated, and mobile energy charging for aerospace or aircraft vehicles which cannot be coupled to stationary (transmissions lines based) vehicle charge systems. The aircraft charging method includes connecting a portable energy source to an energy storage system in the aircraft vehicle and transferring an amount of energy from the portable energy source to the energy storage system in the aircraft. The charging system monitors, using one or more sensor devices, one or more charge condition parameters associated with the charging conditions at said energy storage system of the aircraft vehicle when receiving energy transferred from said portable energy source and detects any condition when a monitored parameter is a value exceeding a threshold level value. In response to detecting a condition when a monitored parameter is of a value exceeding a threshold level value, the charging system responsively initiates a correction.

### BACKGROUND

This disclosure is directed to battery charging systems generally, and more particularly to systems and methods for battery charge and charging control systems for aircraft/aerospace vehicles.

Vehicles such as land-based and marine-based vehicles currently employ battery charging systems that connect to vehicle batteries and charge the battery. Such battery charging system can be a portable system that can be transported to the vehicle, locally connect to the battery through a charge connector/port and provide a charge to increase operational life of the vehicle.

### SUMMARY

A battery charge system and method for an aircraft or aerospace vehicle.

A battery charge system that is portable and adapted to provide remote, isolated, and mobile charging capabilities to stations or aircraft which cannot be coupled to stationary (transmissions lines based) system.

The portable battery charge system and method provides cooling capabilities and charging capability to (an airframe) and monitors/controls the temperature of the energy storage systems that is not specific to a “airport”.

The portable battery charge system and method that provides highly accurate indication and recording of electrical energy transferred into the aircraft.

The portable battery charge system that provides a charging station for aircraft not directly coupled to the/a power grid but rather through microgrids/local power generators/renewable resources/large batteries used to charge other batteries.

In one aspect, there is provided an aircraft vehicle charging system. The aircraft vehicle charging system comprises: a charger having at least a first connector for connection to a portable energy source that is not connected to an electrical power grid and a second connector for connection to an energy storage system in an aircraft being charged, the charger adapted to transfer energy from the portable energy source to the energy storage system in the aircraft; one or more sensor devices adapted to monitor charge conditions associated with the energy storage system in the aircraft vehicle when receiving energy transferred from the portable energy source when charging the energy storage system in the vehicle; and a hardware processor associated with a memory storing program instructions in a computer system, the hardware processor running the program instructions configuring the hardware processor to: monitor one or more charge condition parameters associated with charging conditions at the energy storage system in the aircraft while being charged; detect when a monitored charge condition parameter associated with a charging condition is a value exceeding a threshold level value; and initiate a correction of the charging condition in response to detecting a monitored charge condition parameter associated with the charging condition is a value exceeding the threshold level value.

In a further aspect, there is provided a method of charging an aircraft vehicle. The charging method comprises: connecting at least a first connector of a charger to a portable energy source that is not connected to an electrical power grid and connecting a second connector of the charger to an energy storage system in an aircraft being charged, the charger transferring energy from the portable energy source to the energy storage system in the aircraft; monitoring, using one or more sensor devices, one or more charge condition parameters associated with charging conditions at the energy storage system of the aircraft when receiving energy transferred from the portable energy source; detecting, using a hardware processor, when a monitored charge condition parameter associated with a charging condition is a value exceeding a threshold level value; and responsively initiating, by the hardware processor, a correction to the charging condition in response to detecting a monitored charge condition parameter associated with the charging condition is a value exceeding the threshold level value.

A computer readable storage medium storing a program of instructions executable by a machine to perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 depicts a generic block diagram of an aircraft aerospace charging system and in an embodiment;

FIG. 2 conceptually depicts an embodiment of an energy supply system of the portable battery charging system for the aircraft that includes an interconnection of one or more isolatable energy sources;

FIG. 3 depicts a system implementation including an out of system controller in the form of an external satellite that can communicate electromagnetic signals with a satellite communications receiver for operating/updating the charging system via a direct communication link;

FIG. 4 depicts an embodiment showing physical connections from the energy supply sources via respective power cabling to the charging system and likewise, physical connections via respective power cabling from the charging system to one or more aircraft needing to be charged;

FIG. 5 depicts an example charging/parameter monitoring operation at an aircraft in an embodiment; and

FIG. 6 depicts an embodiment of a method implemented at the charging system for use in charging an aircraft or aerospace vehicle using the system of FIG. 4.

### DETAILED DESCRIPTION

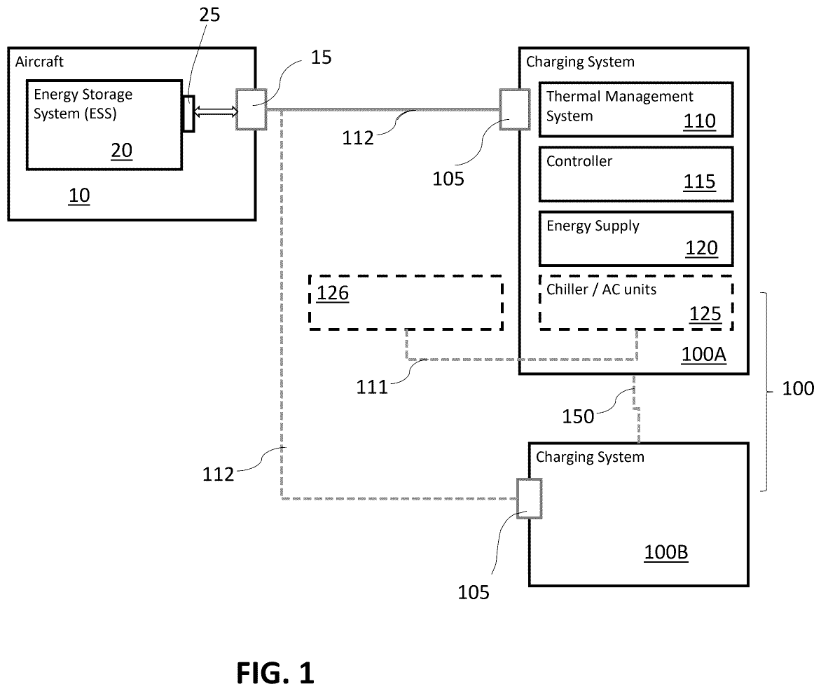

FIG. 1 depicts a block diagram of a transportable battery charging system 100 for aircraft and/or aerospace vehicles 10. The transportable battery charging system 100 for aircraft and/or aerospace vehicle 10 (hereinafter “aircraft”) includes a portable charging system 100A having a power source 120 and a plug-in port connector 105 for providing a direct charging connection to the aircraft battery or aircraft Energy Storage System (ESS) 20 including devices such as one or more aircraft vehicle batteries/battery energy storage systems (BESS). A second similar charging system component 100B provides a further charging in the event there are multiple charges working together, e.g., when the system is used to charge more than one aircraft energy storage system, e.g., multiple batteries.

As known, aircraft energy storage systems are typically high energy density electrochemical batteries (e.g., Ni—Cd, Li-ion, lead acid, etc.) that are configured to provide a variety of functions, e.g., propulsion system batteries for starting of internal engines (ESG), power units that include battery and super/ultra-capacitors, flight control actuation, and a fault tolerant power management and distribution and motor drive system. These batteries typically provide hundred watt-hours to hundreds of kilowatt-hours or megawatt-hours. Aircraft batteries are further implemented to maintain the electrical AC/DC bus at a constant voltage, e.g., under dynamic conditions, and powering up the necessary avionic equipment/instruments, e.g., in case of emergency. Although not shown, in an aircraft, a BESS includes multiple batteries connected in series to provide one or more DC busses for powering various aircraft operations. In an embodiment, one DC bus can include a 270 VDC bus for aircraft power distribution (AC/DC loads) at multiple kilowatts. A further 28 VDC bus can be provided for powering flight control units (e.g., DC loads) or anything off-the high voltage system. The BESS power distribution network provides for bidirectional power flow capability to enable the battery to be charged and discharged over a period of time.

The charging system component 100A (and similarly charging system 100B) includes one or more of: a thermal management system 110 for maintaining a proper temperature condition of the charger when charging the aircraft energy storage system; a power source or energy supply 120 used for supplying the energy used to charge the aircraft ESS; an optional cooling system or air conditioning unit 125 used as part of the thermal management system to cool charging components when charging the aircraft ESS. A further controller unit 115 which can include a hardware processor-based control unit is programmed to coordinate operations of the thermal management, energy supply charge management, and cooling system/air conditioning units across each system to ensure proper charging conditions. The controller unit is configurable to know which battery system in the aircraft is being charged, and provide proper charging based on the current state of the vehicle battery. The controller unit 115 can control how the battery systems are brought on/off in the system in order to provide sufficient power to charge the battery without violating specific design considerations in order to maintain safety for the aircraft and the charger while ensuring no catastrophic failure. In an embodiment, controller unit 115 communicates with aircraft 10 to be charged and the power source 120 to ensure the various electrical parameters (voltages, currents, kWh, and Ampere-hours (Ah)) of each system are maintained within the safety operational ranges as defined by the system prior to and during the exchange of energy. In a further embodiment, the cooling system/air conditioning unit 126 can be “off board” of the physical charging system 100 and separately connected to system 100 but still controllable via controller 125 via a communications connection or link 111.

As shown in FIG. 1, both the portable battery charging system 100 components 100A, 100B, whether operating alone or in concert to charge the aircraft ESS 20 for aircraft and/or aerospace vehicle 10 (hereinafter “aircraft”) each include a port/connector 105 that accommodates engagement with a suitable energy HVDC charging cable 112 that can physically connect to a corresponding mating plug-in port/connector 15 of the aircraft 10 that can receive the charge from charging system 100A, 100B. In embodiment, energy charging cable can include a high voltage direct current (HVDC) cable 112 connecting charge connector port 105 at the charging system and connector 15 at the aircraft. The charge cables 112 can also be configured to communicate messages between the controller 115 of charge system 100 and a battery charge control/management unit 25 at the aircraft ESS. In an embodiment, charge cables 112 support multiple current and voltage ranges and are configurable based on specific aircraft 10. The baselined features include operating at 1000 VDC, 500 Amps (continuous), 750 Amps (peak), and over a distance of 40 feet. The cables provide two (2) communications buses which are used to transmit operational data and commands to and from aircraft 10 to charging system 100. In embodiments, via HVDC cabling 112, the battery management system (BMS) 25 communicates with the charging system controller 115 and negotiates with the charging system controller 115 to ensure the proper amount of power in kilowatt-hours at a specific charging rate is transferred to the aircraft battery via the charger 100 based on the type of input energy source to the aircraft, the size of the high voltage charge cabling, and the current state of the aircraft battery/batteries, etc., The aircraft BMS or a similar high voltage distribution system provides scalability to locally control the distribution of the received energy to one or more batteries or ESS systems of the aircraft.

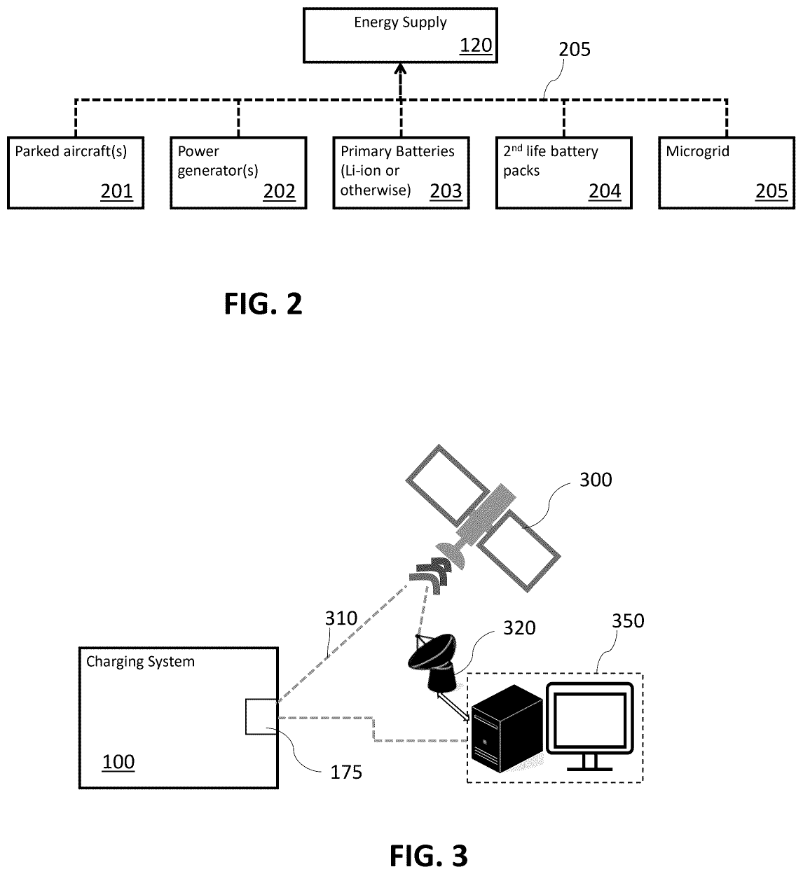

Referring to FIG. 2, in one embodiment, the energy supply system 120 of the portable battery charging system 100 for the aircraft can include a connection 205 to one or more isolatable energy sources, each operable individually or in combination, to provide power for charging an aircraft battery or energy storage system. Isolation of the energy source(s) in this context means isolated and separated from an external charging source such as a large transmission (e.g., a national or local utility) grid. The charger's energy sources include but are not limited to a power bank such as: a battery or like power sources at a second parked aircraft 201 (e.g., proximately located to the aircraft to be charged), an electric power generator(s) 202 such as can be powered by a gas power source or a solar panel, a primary battery system (e.g., Li-ion or otherwise) 203, a second life battery pack(s) 204 which are battery packs that have reached near the end of their designed life (e.g., operational cycles or ability to meet the aircraft's operational profiles (kW vs time at the applicable voltage and current . . . )). These battery packs may be combined in additional second life “packs” to create sufficient Ah or Wh capabilities at reduced charge-rates thus maximizing their usable energy extraction. The charger's energy sources can also include a microgrid 205. In an embodiment, the physical microgrid 205 can include one or more energy producing resources including, but not limited to: a wind turbine(s) or solar panel(s)/solar generators, diesel generators (not shown), etc. Some or more of these energy resources can be connected together by conductors or conductive links to form an individual microgrid of distributed energy resources providing energy (power) for powering the battery of an aircraft. Alternatively, the energy supply 120 can be an electrical energy supply system, including, but not limited to, an additional aircraft battery or ESS, a power generator (e.g., gas turbine, nuclear reactor (micro or otherwise), micro-grid support, wind-turbines, pump power station, hydro-power station) or an additional electric (or hybrid) power source that can be used to separately power the aircraft. At aircraft charging time, the controller 115 of charging system 100 can identify a connected power source 201, . . . , 205, and control the flow of energy from the power source to the aircraft using a control flow method implementing monitoring sensors to ensure appropriate charging conditions. In embodiments, the charging system for aircraft is not necessarily directly coupled to the/a power grid, i.e., it can be coupled through microgrids/local power generators/renewable resources/large batteries used to charge other batteries.

As further shown in FIG. 1, the controller unit 115 is integrated within and the charging system 100 and interfaces with the aircraft 10 and/or ESS 20. In an embodiment, the controller communicates with the aircraft ESS and provides control signals (e.g., encrypted/unencrypted), communicated over charge system cabling 112, for controlling charge applied to the aircraft battery and/or ESS. In an alternate embodiment, the charging system 100 can interface with an external (out of system) controller for controlling aircraft charging system 10. In an embodiment, the charging system may be connected to other charging systems to meet a specific power demand. For example, the charging system can coordinate across other charging systems to maintain one “leader” while the other charging systems “followers” follow the commands of the leader which is communicating and coordinating directly with the aircraft. As a further example, as shown in FIG. 3, an external (out of system) controller can be a satellite 300 in earth's geosynchronous orbit that can communicate electromagnetic signals with a satellite communications receiver 175 at the charging system 100, e.g., along a direct communication link, to provide control signals 310 for controlling aircraft charging system operations. In an embodiment, the satellite can provide software/firmware updates for the charging system 100 as well as system diagnostics information (data) for both the charging system and the systems interfacing to the charger 100.

In an embodiment, an onsite resource, such as a computer system 350 includes a satellite communications receiver 320 receiving data and/or control signals from GPS satellite 300 that can be processed and communicated to the charging system 100 when used to charge an aircraft. The Onsite computing resource 350 can download, upload, and complete maintenance operations for the charger system 100. In an embodiment, onsite computing resource 350 could be a person with a laptop, a large truck or vehicle with communications equipment (e.g., hardwired or via a wireless system).

In an embodiment, the charging system 100 monitors various parameters from both within its internal system but also the interfacing systems, e.g., port connections, cabling, etc. to: the controller 115, which can be a standalone system that interfaces via (configurable) digital communication protocols (specifically TCP/IP, controller area network (CAN), and various RS (recommended standards); the thermal management system 110 controllers (pump controllers, valve controllers, sensors . . . ) that communicate with air conditioning units 125 (e.g., via ethernet/CAN/digital communications/configurable); circuit breaker controllers (electrical distribution controllers, PID, voltage and current sensors . . . ) which can be part of controller 115; and the energy supply 120 which may be external to the charger, and if so, it would use the/a dedicated port (ethernet/CAN/digital communications/configurable) to transmit and receive information on. The various parameters being monitored include, but are not limited to: temperature, current, state of charge (battery specific), energy transferred, power transferred, operating state and a system configuration. In an embodiment, the monitoring of parameters enables the charger system 100 to control contactors, “breakers”, or solid state switches, which allow for the transfer of power to the interfacing systems depending where the charger is transferring power to and from.

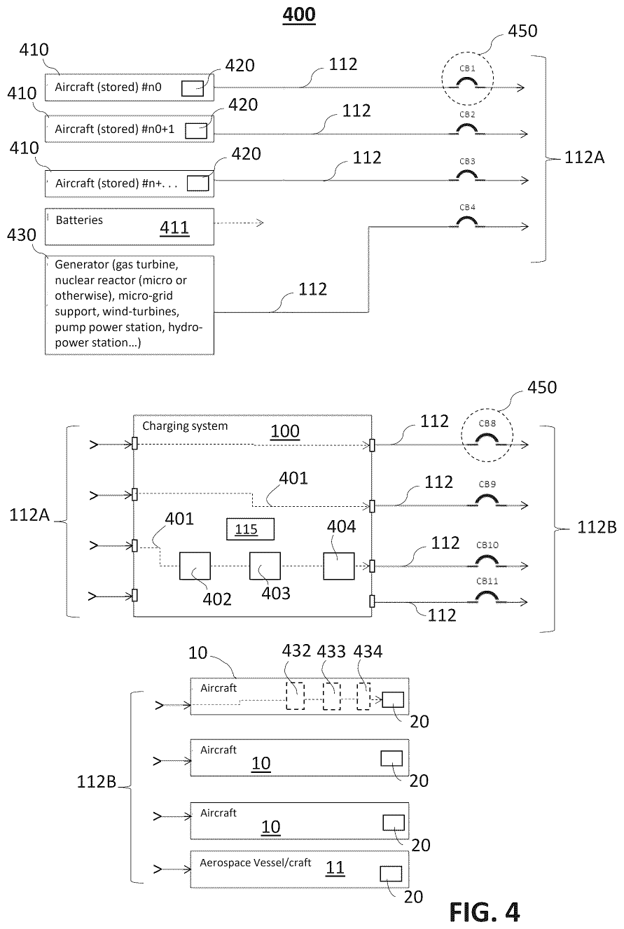

FIG. 4 depicts an embodiment showing physical connections 400 from the energy supply sources 410 via respective power cabling to the charging system 100 and likewise, physical connections via respective power cabling from the charging system to one or more aircraft 10 needing to be charged. For example, one or more “stored” energy devices such as aircraft 410 that is stored or lays idle at a hangar each include an ESS system 420 (e.g., charged battery) that can be tapped as an energy source for supplying power for the charging system 100 to transfer power to another aircraft 10 needing to be charged. A respective aircraft ESS 420 provides under control of the charging system 100 an energy flow to a respective aircraft 10 for storage at its respective ESS 20 over HVDC cabling 112. A stand-alone chemical battery energy source or batteries 411 can be further connected via cabling (not shown) to the charging system 100. Further, a generator 430 (e.g., gas turbine, nuclear reactor (micro or otherwise), micro-grid support, wind-turbines, pump power station or hydro-power station) can further be connected via HVDC cabling 112 to the charging system 100 for supplying energy to an aerospace vessel/craft 10 needing to be charged. Each individual HVDC cable 112 of cabling 112A carrying direct current flow from the energy sources 420 (and/or battery source 411 and generator 430) to charging system 100 includes a respective circuit breaker element 450 configured to protect the charging system from any damage due to any overcurrent flow in the cable and interrupt the current flow to protect the charging system equipment during the transfer of power to the aircraft 10 through the charging system. Similarly, individual HVDC cable 112 of cabling 112B carrying energy (i.e., direct current flow) from the charging system 100 to the respective aircraft 10 to be charged includes a respective circuit breaker element 450 for protecting the aircraft and charging system from any damage to any overcurrent flow and is configured to interrupt current flow to protect the charging system and aircraft ESS 20 during the transfer of power to the aircraft 10 through the charging system.

The charging system 100 is capable of interfacing to multiple energy systems and systems to be charged between the power levels. In an embodiment, the charging system 100 is configurable to achieve a balance between power, cost, desire charge time, and function: e.g., a charge ranging from between 1 MW to 1 GW, e.g., 50 MW to 500 MW; a charge from 600 VDC to 1500 VDC; a charge from 480 VAC to 1500 VAC, e.g., at 50 A to several kiloamperes.

In an embodiment, the charging system 100 controller 115 will control the circuit breakers 450 and control the power movement to and from the different power sources over power conductor lines 401. Under control of controller 115 (a processor unit), the charger 100 will use various power electronics to control the different voltages and current moved between the various systems in order to ensure no damage is caused due to one or more of: overcurrent, overvoltage or over temperature situations.

For example, the charging system controller 115 implements various algorithms to control how the charging system calculates and stores various parameters of all systems. The parameters tracked and stored in a memory associated with the controller include, but are not limited to: 1. State of Charge where in an embodiment, the charging is under cyber-messaging controls; 2. Power transferred in a manner such that there is provided a highly accurate indication and recording of electrical energy transferred into the aircraft; 3. Temperature where the charging system monitors/controls the temperature of the energy storage systems that is not specific to an “airport”; 4. Coolant flow where the charging system provides cooling capabilities and charge capability to the aircraft; 5. Impedances; and 6. Faults and fault logs.

In an embodiment, the charging system controller 115 further provides safety critical controls and redundancies which follow aerospace industry standards allowing for design assurance levels and failure probabilities which support aircraft certification and qualification designations in accordance with the various type certifications needs of OEMs (airframers) or aircraft operators. As shown in FIG. 4, the safety critical controls include monitoring sensors, e.g., sensors such as electrical current sensors 402, voltage sensors 403, temperature sensors 404, etc. located at the charging system, and like current sensors 432, voltage sensors 432, temperature sensors 434, etc. located at the aircraft being charged) and a combination of the sensors which, when aggregated together, provide a complex operation state and feed the charging system's control algorithms run at the controller 115 which are inherent to the continued and safe operations of all systems connected to the charger.

In an embodiment, one of the control algorithms run at the controller 115 tracks the state of charge (SoC) of the energy storage system, e.g., aircraft battery, where the State of Charge (SoC) is a function of the voltage, current and temperature of the energy storage systems, i.e.,

$$SoC ( system ) = ( \begin{matrix}{SoC}_{( system n )} \\ {SoC}_{( system n + 1 )} \\ {SoC}_{( system n + m ) )}\end{matrix} where SoC = f ( V , I , T ) .$$

The performance characteristics vary based on the type of chemical storage system and will be unique to each ESS. The SoC dynamic value will be provided by external systems to the charger. As the SoC of the individual systems changes, the charger will dynamic change the amount of energy being transferred by the energy sources to limit/maximize the amount of energy the charger can provide to the aircraft. The Charger can complete this by a variety of ways including, but not limited to:
1. maximizing the flow (i.e., current) of the charging system subject to the restrictions of the aircraft's maximum charge currents, temperature limitations, the charging and aircraft cooling needs, minimize charge time, and minimize SoC change to all energy sources;
2. Ensure the capacity (viewed as constraints) of the energy sources, aircraft, and the charger cables are maintained; and
3. optimizing the current pulled from the energy sources based on recharging the energy source.

For example, given two energy sources: (1) being a gas turbine generator, (2) being a second-life battery, the charging system would limit the demand from (2) to low currents and maximize current demand from the gas turbine generator (1) initially to both improve the life and operational range of second-life battery (2) and to limit the recharge time needed for second-life battery (2) (this being based on the underlying understanding of a gas turbine generators performance).

In a further embodiment, the charger 100 monitors the HVDC (high voltage DC interfaces) to both the aircraft and the energy sources to limit the VDC, IDC, and transients of (the VDC, IDC) to within the operational ranges of each interface. The charger 100 maintains these values within the charges memory (digital) storage area defined as the fault and error memory. The Charger periodically (e.g., 10 times per second) verifies all interfaces have not exceeded these values based on the readings of the current and voltage sensors (not shown). Should a sensor fail during this time, the Charger uses redundancy and integrity checks to limit risk and ensure safety, and the Charger will provide the information to the external systems and prevent continued Charger operations until the error or fault is corrected.

The Charger monitors internal temperatures of the charging system 100, as well as receives temperatures from external systems. Should an external system report exceeding operational temperatures, the charger will take action to eliminate the operational impact to the external systems (e.g., by increasing the coolant to system, lowering the coolant temperature, or reducing/removing the current to/from the external system). The Charger uses temperature sensors within the TMS and receives digital communication detailing this information about external systems through either the charging cables or the energy source cables/communication bus.

The Charger 100 monitors for ground faults, over-current, short-circuits on all electrical interfaces. The Charger's ground faults are predetermined during the Charging systems integration and on-site setup with the energy sources to accommodate various ohms per voltage changes, again based on the number of interfacing systems. The System uses voltage monitors (not shown) for this safety action.

The Charger 100 uses simple routine checking and monitoring of to accomplish the actions above.

The charger 100 is capable of providing and controlling the coolant (variable type) to the interfacing systems. It can provide cooling and heating to the systems. The charging system is required to perform this function within the charging schema—this is dependent on the external system's needs. In an embodiment, the external systems include, e.g., systems external to the chassis of the charging systems energy sources, aircraft, and the external to the charger's chassis chilling or heating equipment, i.e., systems non-permanently fixed to the charger equipment. In an embodiment, in view of FIG. 4, any power/current transferred to an interfacing system (i.e., the vessel/craft being charged) defines “how much fuel has been transferred to the system”. The fuel, available to the system being charged, prior to starting the subsequent operation is critically important in the event that a loss or inaccurate/erroneous indication occurs during any operation(s).

In an embodiment, the charging system's controller 115 further records a datetime stamp log for both events and parameters. The log size varies based on the charging system's maintainer's/operator's needed access intervals. Should the operator need to limit access or communications with the charging system this log will increase in size.

The charging system controller 115 has a custom emergency notification system which operates across various communication devices and across multiple electro-magnetic spectrum bands and physical mediums. This function ensures that during emergency situations there is at least one method for the charging system to elicit assistance during failures or fault situations. This could include external systems failures or emergency request by a person/entity around the charging system.

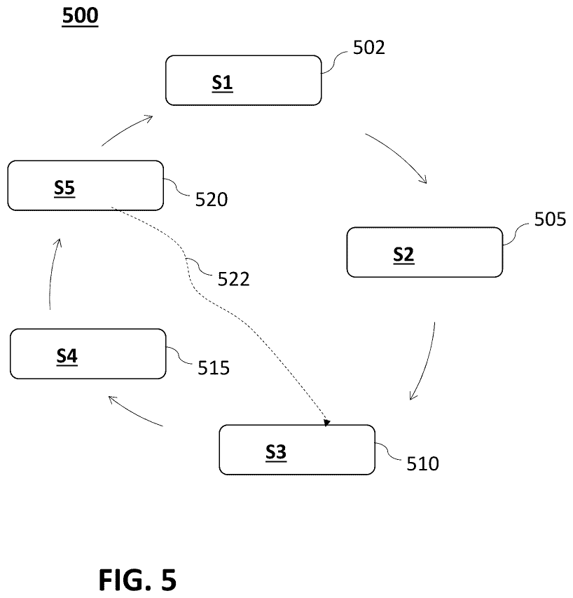

FIG. 5 depicts an example of a charging/parameter monitoring operation 500 at an aircraft: For purposes of discussion, the system to be charged (aircraft battery/energy storage system) is referred to as “System_A” however, this could be a multitude of systems. At 502, a first step S1 shows the System_A (aircraft) as being connected to the charging system 100 (FIG. 4). In an embodiment, a maintenance crew/charger system operator connects the charging cable(s) and thermal management system (TMS) coolant lines to the external system (e.g., aircraft, energy source). Then at 505, a second step S2 shows the charging system establishing positive communication with the aircraft's battery management system and calculating the power/current levels required to charge the craft to a specific level. In embodiments, the charger and external systems establish communications and pass operational parameters between each system, The communications between an aircraft and the charging system 100 can be by both secure (cypher-based or encrypted-based) messaging (e.g., to prevent man-in-the-middle attacks) or open communication systems (i.e., non-encrypted) depending upon the application. Continuing to step 510, the charger system 100 in a third step S3 prepares and verifies all internal systems (however, excepting System_A) are functioning as required and safely. In an embodiment, the charger maintains internal and external temperatures through the TMS system by changing flow rates, coolant temperatures, etc., to maintain the external (and internal) systems within the parameters established at step 505. Then at 515, at S4, the charger begins to charge System_A and continues to monitor all system parameters. In an embodiment, the external systems provide feedback/updated temperatures to the charger periodically and upon request of the charger. Continuing to 520, at S5, the charger system completes the charge (the actual “charge” parameters current/voltage/temperature, are variable and will be coordinated during the step S2. the charger transfers information to System_A and records information about the charge into a records data management system (e.g., either secure or unsecure) for future diagnostics and management. In a further embodiment, the charger is configurable to throttle current to reduce temperature effects if operational temperatures cannot be maintained solely through the usage of the TMS and can continue the monitoring operation at 522 by returning back to and repeating step 510.

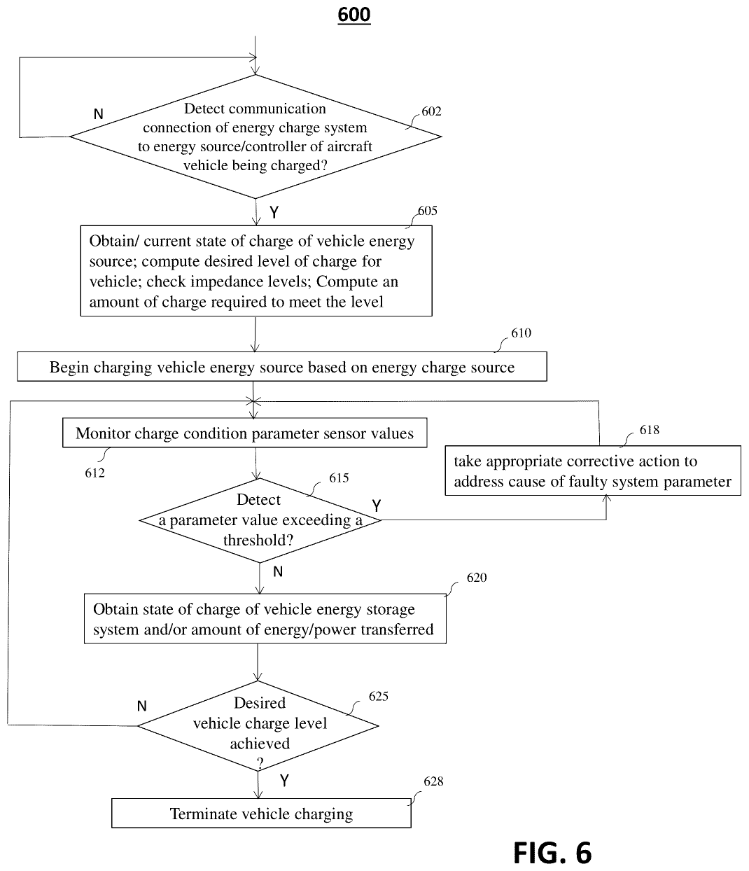

FIG. 6 depicts an embodiment of a method implemented at the charging system for use in charging an aircraft or aerospace vehicle using the system of FIG. 4. In FIG. 6, a first step 602 involves the system detecting a connection of energy charge system to an energy source/controller of an aircraft vehicle being charged. In an embodiment, the physical hardwire connection in cabling 112 provide the conduit for establishing electronic communications between the charging system controller and the energy storage system of the aircraft. Electronic communications can be exchanged digitally via a known encrypted protocol. Once communications is established, then, at 605, by reading certain parameters, the charging system obtains a current state of charge (SoC) of the vehicle energy source and based on the current SoC, derives a desired level of charge (i.e., power) to be transferred to the vehicle. For example, a aircraft vehicle 10 may be used for a long trip or flight plan or is activated to perform a mission requiring use of all of its potential power, and the system responsively can activate an energy source programmed to fully charge the vehicle power or energy storage system so that the vehicle can become maximally charged. This step may entail checking impedance levels of both the energy source and the vehicle's energy storage system being charged and computing an amount of charge required to meet the level. Once a desired charge level is determined, the method continues to 610, where the vehicle charging is initiated, e.g., the power source is activated to provide charging current to the vehicle's energy storage system. The aircraft battery charging can be fast direct current rapid charging method, or a slow rate trickle charging method, etc.

While the charging takes place, the charge system, at 612, FIG. 6, monitors various system parameters indicative of the charging condition. In particular, during the charging, various system sensors such as current sensors, voltage sensors, temperature sensors, etc. located at the charging system and located at the aircraft being charged are accessed and real-time system sensor values from system sensors are obtained for safety/monitoring purposes. In non-limiting examples, sensed parameters from system interfaces can include temperature, current, voltage, State of Charge (battery specific), energy/power transferred, operating state, and system configuration. Generally, if any of these sensed values exceed some threshold value or are indicative of error, then corrective action may be taken, e.g., such as by activating a circuit breaker to terminate the charging, or modifying a charge rate, etc. For example, if a sensed temperature value of the aircraft battery exceeds a pre-determined threshold value, then this can be communicated to the charging system over the charge cable and the charging system can responsively activate a cooling unit capability to control the temperature of the ambient or the aircraft battery. For example, the control of the heat generated at the aircraft can be further controlled by controlling the ambient air in which the aircraft is housed. However, a direct cooling coupling to the aircraft with a hose or a ventilation to provide liquid or air cooling to the aircraft and battery system can be implemented. Similarly, the temperature of the charging system 100 can be regulated upon detecting that the charging system temperature has exceeded a pre-determined threshold, e.g., by regulating the thermal management system 110 and any air cooling units 125.

Thus, continuing, at 615, a determination is made as to whether a sensed parameter value exceeds a pre-determined threshold value. If, at 615, it is determined that the sensed parameter value, e.g., temperature, exceeds the threshold value, the method continues to 618 to respond by taking appropriate corrective action to address the faulty system parameter. For example, in the case of detecting an excessive temperature charging condition, corrective action can involve activating a cooling air conditioner unit or increasing a ventilation of the area so that the charging system and/or aircraft battery can remain within proper temperature bounds. From step 618, the method returns to step 612 so as to continue monitoring the charge condition sensor values, e.g., the temperature sensor, and the loop involving steps 612, 615, 618 is repeated. Once the faulty system parameter (e.g., temperature) is brought under control by the activation of air conditioning unit or like chilling unit at step 618, the method continues to 620 in order to obtain a state of charge or like metric indicating the amount of vehicle energy or power that has been transferred. Continuing to step 625, FIG. 6, the method determines whether the desired vehicle charge level has been achieved taking into account the initial SoC or power levels of the aircraft battery. If the desired vehicle charge level has not been achieved, the method returns to 612 to continue the monitoring of the vehicle charging conditions and repeat steps 612, 615, 620, 625 until such time as the desired charge level of the vehicle's energy storage system has been achieved. Once the desired charge level of the vehicle's energy storage system has been achieved, the vehicle ESS charging is terminated at 628.

As used herein terms such as “a”, “an” and “the” are not intended to refer to only a singular entity, but include the general class of which a specific example may be used for illustration. As used herein, terms defined in the singular are intended to include those terms defined in the plural and vice versa.

References in the specification to “one aspect”, “certain aspects”, “some aspects” or “an aspect”, indicate that the aspect(s) described may include a particular feature or characteristic, but every aspect may not necessarily include the particular feature, structure, or characteristic. Moreover, such phrases are not necessarily referring to the same aspect. Further, when a particular feature, structure, or characteristic is described in connection with an aspect, it is submitted that it is within the knowledge of one skilled in the art to affect such feature, structure, or characteristic in connection with other aspects whether or not explicitly described.

As described herein, aspects of the present disclosure may include one or more electrical, pneumatic, hydraulic, or other similar secondary components and/or systems therein. The present disclosure is therefore contemplated and will be understood to include any necessary operational components thereof. For example, electrical components will be understood to include any suitable and necessary wiring, fuses, or the like for normal operation thereof. Similarly, any pneumatic systems provided may include any secondary or peripheral components such as air hoses, compressors, valves, meters, or the like. It will be further understood that any connections between various components not explicitly described herein may be made through any suitable means including mechanical fasteners, or more permanent attachment means, such as welding or the like. Alternatively, where feasible and/or desirable, various components of the present disclosure may be integrally formed as a single unit.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments can be implemented in any of numerous ways. For example, embodiments of technology disclosed herein may be implemented using hardware, software, or a combination thereof. When implemented in software, the software code or instructions can be executed on any suitable processor or collection of processors, whether provided in a single computer or distributed among multiple computers. Furthermore, the instructions or software code can be stored in at least one non-transitory computer readable storage medium.

Also, a computer or smartphone may be utilized to execute the software code or instructions via its processors may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers or smartphones may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

The various methods or processes outlined herein may be coded as software/instructions that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, USB flash drives, SD cards, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the disclosure discussed above. The computer readable medium or media can be transportable, such that the program or programs stored thereon can be loaded onto one or more different computers or other processors to implement various aspects of the present disclosure as discussed above.

The terms “program” or “software” or “instructions” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present disclosure need not reside on a single computer or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments. As such, one aspect or embodiment of the present disclosure may be a computer program product including least one non-transitory computer readable storage medium in operative communication with a processor, the storage medium having instructions stored thereon that, when executed by the processor, implement a method or process described herein, wherein the instructions comprise the steps to perform the method(s) or process(es) detailed herein.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

All definitions, as defined and used herein, should be understood to control over dictionary definitions, definitions in documents incorporated by reference, and/or ordinary meanings of the defined terms.

“Logic”, as used herein, includes but is not limited to hardware, firmware, software, and/or combinations of each to perform a function(s) or an action(s), and/or to cause a function or action from another logic, method, and/or system. For example, based on a desired application or needs, logic may include a software controlled microprocessor, discrete logic like a processor (e.g., microprocessor), an application specific integrated circuit (ASIC), a programmed logic device, a memory device containing instructions, an electric device having a memory, or the like. Logic may include one or more gates, combinations of gates, or other circuit components. Logic may also be fully embodied as software. Where multiple logics are described, it may be possible to incorporate the multiple logics into one physical logic. Similarly, where a single logic is described, it may be possible to distribute that single logic between multiple physical logics.

Furthermore, the logic(s) presented herein for accomplishing various methods of this system may be directed towards improvements in existing computer-centric or internet-centric technology that may not have previous analog versions. The logic(s) may provide specific functionality directly related to structure that addresses and resolves some problems identified herein. The logic(s) may also provide significantly more advantages to solve these problems by providing an exemplary inventive concept as specific logic structure and concordant functionality of the method and system. Furthermore, the logic(s) may also provide specific computer implemented rules that improve on existing technological processes. The logic(s) provided herein extends beyond merely gathering data, analyzing the information, and displaying the results. Further, portions or all of the present disclosure may rely on underlying equations that are derived from the specific arrangement of the equipment or components as recited herein. Thus, portions of the present disclosure as it relates to the specific arrangement of the components are not directed to abstract ideas. Furthermore, the present disclosure and the appended claims present teachings that involve more than performance of well-understood, routine, and conventional activities previously known to the industry. In some of the method or process of the present disclosure, which may incorporate some aspects of natural phenomenon, the process or method steps are additional features that are new and useful.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

While components of the present disclosure are described herein in relation to each other, it is possible for one of the components disclosed herein to include inventive subject matter, if claimed alone or used alone. In keeping with the above example, if the disclosed embodiments teach the features of components A and B, then there may be inventive subject matter in the combination of A and B, A alone, or B alone, unless otherwise stated herein.

As used herein in the specification and in the claims, the term “effecting” or a phrase or claim element beginning with the term “effecting” should be understood to mean to cause something to happen or to bring something about. For example, effecting an event to occur may be caused by actions of a first party even though a second party actually performed the event or had the event occur to the second party. Stated otherwise, effecting refers to one party giving another party the tools, objects, or resources to cause an event to occur. Thus, in this example a claim element of “effecting an event to occur” would mean that a first party is giving a second party the tools or resources needed for the second party to perform the event, however the affirmative single action is the responsibility of the first party to provide the tools or resources to cause the event to occur.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures.

To the extent that the present disclosure has utilized the term “invention” in various titles or sections of this specification, this term was included as required by the formatting requirements of word document submissions pursuant the guidelines/requirements of the United States Patent and Trademark Office and shall not, in any manner, be considered a disavowal of any subject matter.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described. The terminology used herein is for the purpose of describing particular embodiments only and is not intended to be limiting the scope of the disclosure and is not intended to be exhaustive. Many modifications and variations will be apparent to those of ordinary skill in the art without departing from the scope and spirit of the disclosure.

1. An aircraft vehicle charging system comprising:
a charger having at least a first connector for connection to a portable energy source that is not connected to an electrical power grid and a second connector for connection to an energy storage system in an aircraft being charged, the charger adapted to transfer energy from the portable energy source to said energy storage system in said aircraft;
one or more sensor devices adapted to monitor charge conditions associated with the energy storage system in the aircraft vehicle when receiving energy transferred from said portable energy source when charging said energy storage system in the aircraft; and
a hardware processor associated with a memory storing program instructions in a computer system, the hardware processor running the program instructions configuring the hardware processor to:
monitor one or more charge condition parameters associated with charging conditions at said energy storage system in the aircraft while being charged;
detect when a monitored charge condition parameter associated with a charging condition is a value exceeding a threshold level value; and
initiate a correction of said charging condition in response to detecting a monitored charge condition parameter associated with the charging condition is a value exceeding the threshold level value.

2. The system as claimed in claim 1, wherein the hardware processor is configured to establish messaging communication with a battery management system at the aircraft being charged, the messaging communication establishing energy transfer conditions between the portable energy source and the energy storage system of the aircraft.

3. The system as claimed in claim 2, wherein the energy transfer conditions comprise one or more of: a power level or a current level required to charge the energy storage system of the aircraft to a specified level.

4. The system as claimed in claim 1, wherein said charge condition parameters comprises a current or voltage parameter associated with the charging of said energy storage system, said hardware processor initiating a termination of the aircraft charging when a current or voltage level exceeds a respective threshold current value or threshold voltage value.

5. The system as claimed in claim 4, wherein said initiating a termination of the aircraft charging comprises: tripping a circuit breaker in series with a direct current (DC) cable connecting the portable energy source to the first connector or tripping a circuit breaker in series with a DC cable connecting the second connector to the energy storage system in the aircraft.

6. The system as claimed in claim 1, wherein said charge condition parameters comprises a temperature parameter associated with a temperature of said energy storage system when being charged, said hardware processor further configured to:
activate a cooling system to modify the temperature of the energy storage system in the aircraft when the temperature exceeds a threshold temperature value while charging.

7. The system as claimed in claim 1, wherein said portable energy source comprises one or more of: a battery, an electric power generator, a gas powered generator, a gas turbine, nuclear reactor (micro or otherwise), micro-grid support, a wind-turbine power source, a pump power station, a hydro-power station, an energy power source at a second aircraft proximately located to the aircraft to be charged, a second life battery pack, or combinations of such portable energy sources.

8. The system as claimed in claim 1, wherein said portable energy source comprises: a microgrid power source including an energy producing resource comprising one or more of: a wind turbine, a solar panel or solar generator, a diesel generator.

9. The system as claimed in claim 1, wherein said hardware processor receives remote instructions from a remotely located device.

10. The system as claimed in claim 9, wherein said remotely located device is a satellite adapted to provide a communication path for software/firmware updates for the hardware processor.

11. A method of charging an aircraft vehicle charging system comprising:
connecting at least a first connector of a charger to a portable energy source that is not connected to an electrical power grid and connecting a second connector of the charger to an energy storage system in an aircraft being charged, the charger transferring energy from the portable energy source to said energy storage system in said aircraft;
monitoring, using one or more sensor devices, one or more charge condition parameters associated with charging conditions at said energy storage system of the aircraft when receiving energy transferred from said portable energy source;
detecting, using a hardware processor, when a monitored charge condition parameter associated with a charging condition is a value exceeding a threshold level value; and
responsively initiating, by the hardware processor, a correction to said charging condition in response to detecting a monitored charge condition parameter associated with the charging condition is a value exceeding the threshold level value.

12. The method as claimed in claim 11, further comprising:
establishing, via the hardware processer, a communication path for communicating messages between the charger and a battery management system at the aircraft being charged, the messaging communication establishing energy transfer conditions between the portable energy source and the energy storage system of the aircraft, the energy transfer conditions comprising one or more of: a power level or a current level required to charge the energy storage system of the aircraft to a specified level.

13. The method as claimed in claim 11, wherein said charge condition parameters include a current or voltage parameter associated with the charging of said energy storage system in the aircraft, said hardware processor initiating a termination of the aircraft charging when a current or voltage level exceeds a respective threshold current value or threshold voltage value.

14. The method as claimed in claim 13, wherein said initiating a termination of the aircraft charging comprises: tripping a circuit breaker in series with a direct current (DC) cable connecting the portable energy source to the first connector or tripping a circuit breaker in series with a DC cable connecting the second connector to the energy storage system in the aircraft.

15. The method as claimed in claim 11, wherein said charge condition parameters includes a temperature parameter associated with a temperature of said energy storage system when being charged, the hardware processor activating a cooling system to modify the temperature of the energy storage system at the aircraft when the temperature exceeds a threshold temperature value while charging.

16. The method as claimed in claim 11, further comprising:
receiving, at said hardware processor, operating instructions from a remotely located device.

17. The method claimed in claim 16, wherein said remotely located device is a satellite adapted to provide a communication path for software/firmware updates for the hardware processor.

18. The method as claimed in claim 11, wherein said portable energy source comprises one or more of: a battery, an electric power generator, a gas powered generator, a gas turbine, nuclear reactor (micro or otherwise), micro-grid support, a wind-turbine power source, a pump power station, a hydro-power station, an energy power source at a second aircraft proximately located to the aircraft to be charged, a second life battery pack, or combinations of such portable energy sources.

19. The method as claimed in claim 11, wherein said portable energy source comprises: a microgrid power source including an energy producing resource comprising one or more of: a wind turbine, a solar panel or solar generator, a diesel generator.

20. The method as claimed in claim 11, wherein said portable energy source comprises: an energy power source at a second proximately located to the aircraft to be charged or a second life battery pack.
